(19) United States
(12) Patent Application Publication
(10) Pub. No.: US 2013/0034444 A1
(43) Pub. Date: Feb. 7, 2013

(54) Dispensing system for odor control with fan

(71) Applicants: Ken Muderlak, Milwaukee, WI (US); Todd Muderlak, Whitefish Bay, WI (US)

(72) Inventors: Ken Muderlak, Milwaukee, WI (US); Todd Muderlak, Whitefish Bay, WI (US)

(73) Assignee: DISPENSING DYNAMICS INTERNATIONAL

(21) Appl. No.: 13/373,063

(22) Filed: Nov. 3, 2011

Related U.S. Application Data
(60) Provisional application No. 61/411,819, filed on Nov. 9, 2010.

(51) Int. Cl. B01F 3/04

(52) U.S. Cl. 416/146 R

(57) ABSTRACT

Apparatus for dispensing fragrance from a refill component that is installed and removed along a vertical axis through an opening at the bottom of the housing of the apparatus.

This Application is based on and claims the benefit of the filing date of U.S. Provisional Patent Application No. 61/411,819, filed Nov. 8, 2010.

### TECHNICAL FIELD

The present invention relates to apparatus for dispensing substance fragrances for odor control. An odor control refill component having an odor control substance is inserted in and removed from a housing of the apparatus along a substantially vertical axis from below. The odor control substance has a fragrance which is emitted from the housing of the apparatus.

### BACKGROUND OF THE INVENTION

Numerous devices and approaches are known for dispensing fragrances for odor control purposes.

The fragrances are dispensed from odor control substances of varying types and forms, including gels, absorbent wicks, liquids, gases and solids. It is well known to incorporate these odor control substances in refill containers which are utilized with dispenser housings or supports. Some prior art dispensers are electrically powered, employing fans and/or heating components to promote fragrance dispensing.

### DISCLOSURE OF INVENTION

The apparatus of the present invention is also for dispensing the fragrance of an odor control substance from a refill component having a quantity of the substance. The substance employed can take a variety of forms, including gels, absorbent wicks, liquids, gases, and/or solids. The apparatus is intended to be mounted on a wall and allows for insertion and removal of a container from the bottom and along a substantially vertical axis. The amount of time and effort to place or remove a refill component can be decreased compared to a dispensing system which requires the removal of a system cover to replace a refill component. This added convenience can be significant.

Also, the refill component includes features which allow for mechanical or electronic lock outs so that only a predetermined refill component can work in a corresponding dispensing apparatus. Further, the refill component can be secured into the dispensing system if required and released by a key or a finger. Additionally, certain settings relating to the insertion of a fresh refill component can be reset or initiated by use of a sensor, such as a micro-switch, to detect the insertion.

The apparatus includes a housing defining a housing interior for receiving the refill component and a housing opening at the bottom of the housing communicating with the housing interior and allowing for the passage of the refill component through the housing opening along a substantially vertical axis between a first position wherein the refill component is located in the housing interior and a second position wherein the refill component is located below the housing, whereby the refill component is selectively alternatively movable substantially vertically upwardly through the housing opening to enable dispensing of the fragrance of the substance by the apparatus or movable vertically downwardly through the housing opening to remove the refill component from the housing.

A fan draws air into the housing interior and past said substance when the refill component is in the first position to entrain said fragrance and dispense the fragrance from the housing.

Other features, advantages and objects of the present invention will become apparent with reference to the following description and accompanying drawings.

### BRIEF DESCRIPTION OF DRAWINGS

FIG. 1 is a front perspective view of apparatus constructed in accordance with the teachings of the present invention;

FIG. 2 is a rear perspective view of the apparatus showing a refill component in the bottom of the apparatus housing;

FIG. 3 is a rear perspective, exploded view showing the refill component removed from the housing;

FIG. 4 is a perspective view of the refill component including a fragrance substance thereof depicted by broken lines;

FIG. 5 is a rear perspective view of the apparatus cover with the refill component disposed in the cover and attached thereto, the fragrance substance not shown;

FIG. 6 is a rear view illustrating a portion of the cover with the empty refill component partially above and partially below the cover bottom;

FIG. 7 is a front perspective view showing a housing back portion and related components, the cover having been removed;

FIG. 8 is an enlarged, cross-sectional view showing portions of latch mechanism employed between the cover and housing back portion;

FIG. 9 is a cross-sectional view of the apparatus illustrating air flow during the dispensing operation;

FIG. 10 is a front elevational view of a second embodiment of the apparatus; and

FIG. 11 is a front elevational view of the embodiment of FIG. 10 with the cover removed.

### MODES FOR CARRYING OUT THE INVENTION

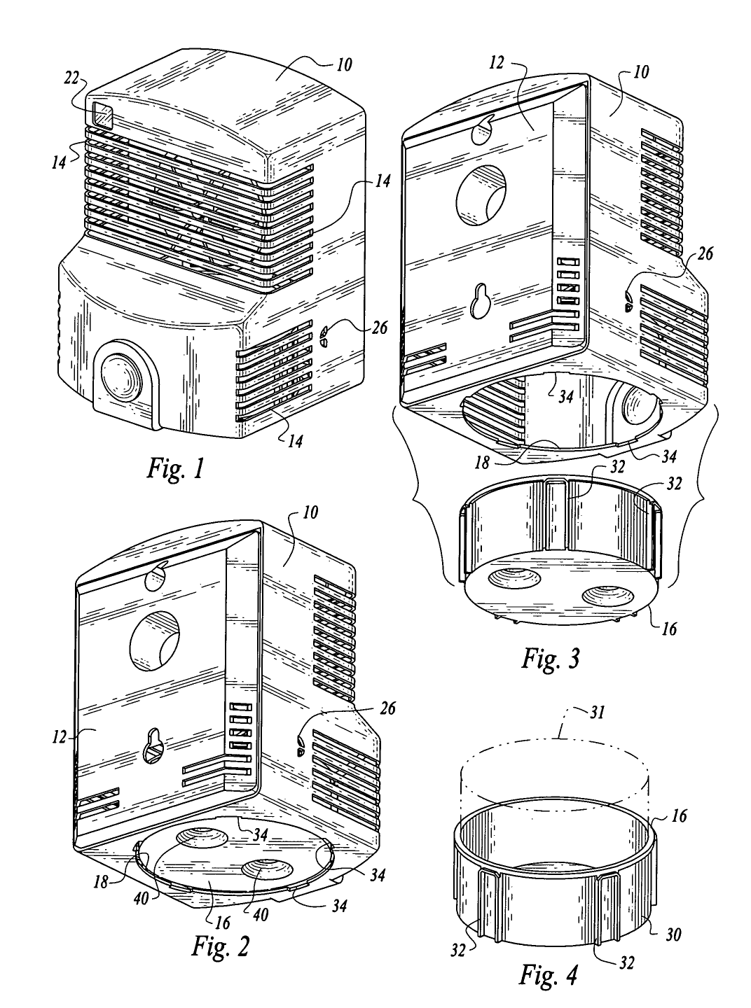

Referring now to FIGS. 1-8, apparatus constructed in accordance with the teachings of the present invention is illustrated. The apparatus has a housing which includes a cover 10 and a housing back 12.

The cover 10 defines air openings 14 for air flow and movement of the, fragrance of an odor control substance of a refill component in the interior of the housing during fragrance dispensing. The apparatus is for installation on a wall, although it can also be placed on a flat surface.

The refill component 16 can be inserted in and removed from the bottom of the housing through a housing opening 18. The refill component 16 has an odor control substance which can take any of a variety of forms including, but not limited to, a gel, wicking substance, liquid, gas, or solid. The housing back 12 to which the cover 10 is connected can incorporate electronics and/or electromechanical controls to control operation of a motor driven fan 20 which is mounted on housing back 12. Batteries 21 (FIG. 7) are shown for providing electrical energy to the motor. It will be appreciated that other sources of electrical energy, such as light harvesting devices, may be employed.

A lens 22 over an access hole in the cover 10 allows for viewing of a user interface output such as an LED 24, or can provide light access for a sensor within the housing to detect an amount of light to make a corresponding day or night determination in order to operate the system at appropriate times.

Key access holes 26 are formed in the cover 10. When an appropriate key is inserted in these holes, a lock mechanism, such as a living hinge lock mechanism 28, can be unlocked to release the cover 10 from the housing back 12. In other embodiments this function could be performed simply with a finger or in other ways. FIG. 8 provides a diagrammatic illustration of the function.

Refill component 16 includes a cup-shaped container 30 defining an interior for accommodating the odor control substance. FIG. 4 depicts an odor control substance 31 in broken lines prior to positioning thereof in the container interior. As indicated above, such substance can be of any suitable type. In the interest of clarity, only FIG. 4 shows an odor control substance.

FIG. 3 illustrates the refill component 16 prior to insertion thereof into the housing interior through housing opening 18.

Projecting outwardly from the outer circumferential wall of container 30 are spaced, elongated male elements 32. Spaced female elements in the form of indents 34 are formed by the cover about housing opening 18.

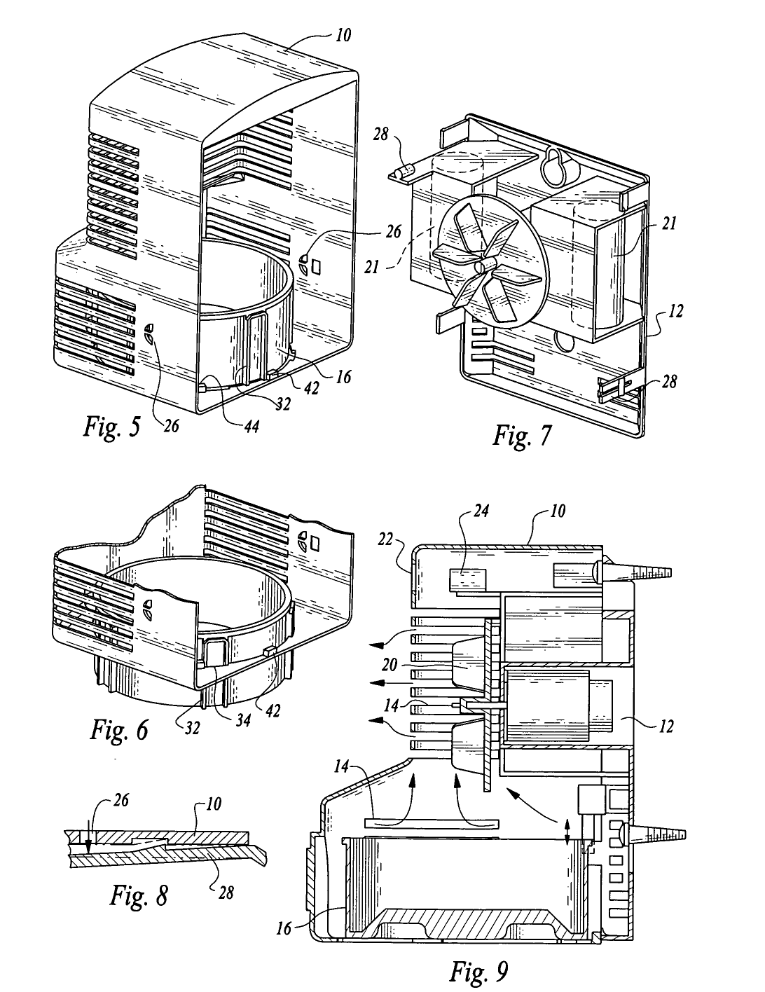

To install the refill component, it is manually moved upwardly through the housing opening. This can only be done when the elongated male elements 32 are aligned with indents 34. Movement is along a substantially vertical axis from a position wherein the refill component is located below the housing (See FIG. 3) to a position wherein the refill component is located in the housing interior (see FIGS. 5 and 9). FIG. 6 illustrates the refill component approximately mid-way between those positions.

Once the bottoms of the male elements 32 clear the bottom wall of the cover, the refill component is turned in one direction. Manual turning is facilitated by use of manually engageable elements in the form of indents 40 located at the bottom of the refill component.

When the refill component is turned, a male element 32 will hit a stop 42 (see FIG. 5) and refill component will rest on the inside bottom surface of the housing. The container 30 is then installed and a bit sub flush (See FIG. 2). To remove the refill component it is rotated in the opposite direction and will hit a stop 44. This aligns the male elements 32 with indents 34 and the refill component readily moves vertically downwardly through the housing opening along the same vertical axis associated with installation of the refill component.

The male elements of the refill component can mate with corresponding features inside the housing to ensure compliancy of use of an appropriate refill component. In other embodiments, other locking/compatibility mechanisms can also be employed, such as use of an electronic lock-out on the refill component that would correspond with a reader on a circuit or printed circuit board.

FIG. 9 illustrates by arrows air flow during operation of the apparatus. The air openings 14 allow the passage of air simultaneously into and out of the housing interior due to operation of the fan 20. Air drawn into the housing interior past the odor control substance entrains the fragrance of the substance and dispenses the fragrance from the housing.

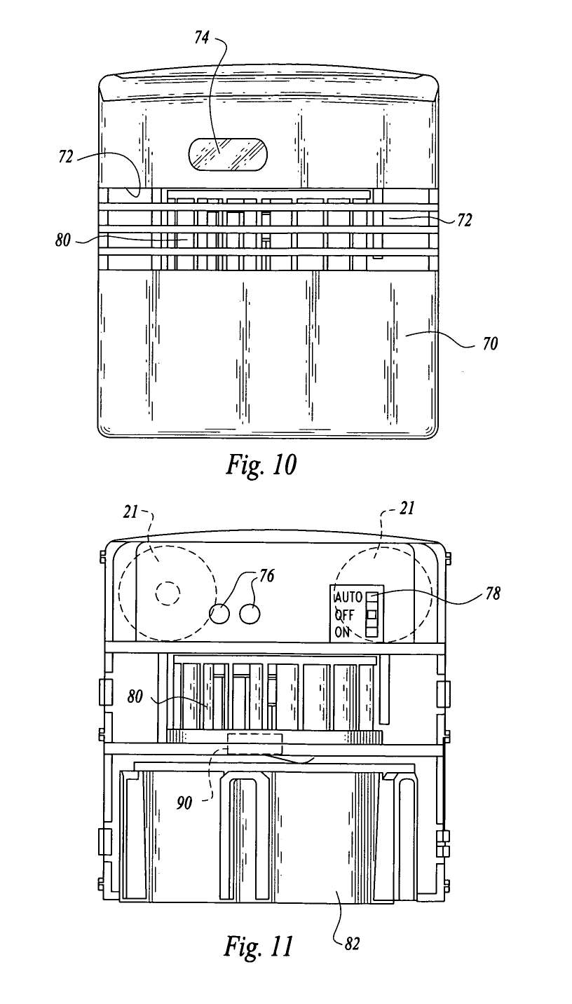

FIG. 10 is a front view of a second embodiment of the apparatus, illustrating cover 70, air openings 72 in the cover, and viewing/access port 74.

FIG. 11 is a front view of the back portion of the dispensing apparatus of FIG. 10, the cover having been removed, and shows one or more LEDs and/or light sensors 76, a switch 78 to control settings such as on/off, day and/or night activation, etc. As shown, fan 80 is a squirrel type fan, although any of a variety of fans can be used. The refill component 82 is inserted and removed in the same manner as described above with respect to the first embodiment.

A micro-switch 90 is employed to detect when a refill component is first inserted in order to power on the system and/or activate one or more predetermined functions such as starting the fan and resetting any refill day counting features that may be employed.

The invention claimed is:

1. Apparatus for dispensing the fragrance of an odor control substance from a refill component having a quantity of said substance, said apparatus comprising, in combination:
a housing defining a housing interior for receiving said refill component and further defining a housing opening at the bottom of said housing communicating with said housing interior and allowing for the passage of said refill component through said housing opening along a substantially vertical axis between a first position wherein said refill component is located in said housing interior and a second position wherein said refill component is located below said housing, whereby the refill component is selectively alternatively movable substantially vertically upwardly through the housing opening to enable dispensing of the fragrance of said substance by said apparatus or movable vertically downwardly through the housing opening to remove the refill component from the housing; and
a fan for drawing air into said housing interior and past said substance when said refill component is in said first position to entrain said fragrance and dispense said fragrance from said housing.

2. The apparatus according to claim 1 including securing structure for releasably securing said refill component to said housing in said first position.

3. The apparatus according to claim 2 wherein said housing includes a housing back portion and a cover movable relative to said housing back portion to open or close said housing.

4. The apparatus according to claim 3 wherein said housing defines a plurality of air openings for allowing the passage of air simultaneously into and out of said housing interior due to operation of said fan.

5. The apparatus according to claim 2 wherein said securing structure comprises structural features on said refill component and on said housing of predetermined compatible character enabling placement of said refill component in said housing interior and releasable securement of said refill component to said housing.

6. The apparatus according to claim 5 wherein said structural features include at least one male element on the refill component and at least one corresponding female element on the cover.

7. The apparatus according to claim 1 additionally including fan control means for allowing energization of said fan responsive to movement of said refill component to said first position.

8. The apparatus according to claim 1 wherein said refill component includes a cup-shaped container defining an interior for accommodating said substance.

9. The apparatus according to claim 5 wherein said refill component is rotatable relative to said housing after movement to said first position to releasably secure the refill component to said housing.

10. The apparatus according to claim 9 including stop structure on said housing for limiting the degree of rotation of said refill component.

11. The apparatus according to claim 2 wherein said refill component includes manually engageable elements utilized to manipulate said refill component and cause said securing structure to releasably secure the refill component to said housing.

12. The apparatus according to claim 2 wherein said refill component and said housing are of predetermined compatible character enabling said refill component to move to said first position.

13. Apparatus for dispensing the fragrance of an odor control substance from a refill component having a quantity of said substance, said apparatus comprising, in combination:
a housing defining a housing interior for receiving said refill component;
a securing mechanism configured to secure the refill component in an engaged position with said housing suitable for dispensation of the fragrance of an odor control substance of the refill component and further configured to release the refill component from the engaged position, the direction of movement of the refill component when released and the direction of refill container insertion being along a substantially vertical axis, and said refill component being inserted and released from the bottom of the apparatus.

14. The apparatus according to claim 13 additionally comprising a fan for dispensing the fragrance or the odor control substance.
